(19) United States
(12) Patent Application Publication
(10) Pub. No.: US 2013/0205314 A1
(43) Pub. Date: Aug. 8, 2013

(54) METHODS AND APPARATUS TO SELECT MEDIA BASED ON ENGAGEMENT LEVELS

(71) Applicants: Arun Ramaswamy, Tampa, FL (US); Padmanabhan Soundararajan, Tampa, FL (US); Alexander Pavlovich Topchy, New Port Richey, FL (US); Jan Besehanic, Tampa, FL (US)

(72) Inventors: Arun Ramaswamy, Tampa, FL (US); Padmanabhan Soundararajan, Tampa, FL (US); Alexander Pavlovich Topchy, New Port Richey, FL (US); Jan Besehanic, Tampa, FL (US)

(21) Appl. No.: 13/691,557

(22) Filed: Nov. 30, 2012

Related U.S. Application Data
(60) Provisional application No. 61/596,219, filed on Feb. 7, 2012.
(60) Provisional application No. 61/596,214, filed on Feb. 7, 2012.

(51) Int. Cl. H04N 21/24

(52) U.S. Cl. CPC H04N 21/24
USPC 725/14

(57) ABSTRACT

Methods and apparatus to select media based on engagement levels are disclosed. An example method includes generating an engagement level based on information related to an audience member in a media exposure environment; and selecting, based on the engagement level, one of a plurality of media collections from which a piece of media is to be select for presentation in the media exposure environment.

### RELATED APPLICATION

This patent claims the benefit of U.S. Provisional Patent Application Ser. No. 61/596,219, filed Feb. 7, 2012, and U.S. Provisional Patent Application Ser. No. 61/596,214, filed Feb. 7, 2012. U.S. Provisional Patent Application Ser. No. 61/596,219 and U.S. Provisional Patent Application Ser. No. 61/596,214 are hereby incorporated herein by reference in their entireties.

### FIELD OF THE DISCLOSURE

This disclosure relates generally to audience measurement and, more particularly, to methods and apparatus to select media based on engagement levels.

### BACKGROUND

Audience measurement of media (e.g., broadcast television and/or radio, stored audio and/or video content played back from a memory such as a digital video recorder or a digital video disc, a webpage, audio and/or video media presented (e.g., streamed) via the Internet, a video game, etc.) often involves collection of media identifying data (e.g., signature(s), fingerprint(s), code(s), tuned channel identification information, time of exposure information, etc.) and people data (e.g., user identifiers, demographic data associated with audience members, etc.). The media identifying data and the people data can be combined to generate, for example, media exposure data indicative of amount(s) and/or type(s) of people that were exposed to specific piece(s) of media.

In some audience measurement systems, the people data is collected by capturing a series of images of a media exposure environment (e.g., a television room, a family room, a living room, a bar, a restaurant, etc.) and analyzing the images to determine, for example, an identity of one or more persons present in the media exposure environment, an amount of people present in the media exposure environment during one or more times and/or periods of time, etc. The collected people data can be correlated with media identifying information corresponding to media detected as being presented in the media exposure environment to provide exposure data (e.g., ratings data) for that media.

### BRIEF DESCRIPTION OF THE DRAWINGS

FIG. 1 is an illustration of an example exposure environment including an example audience measurement device disclosed herein.

FIG. 2 is a block diagram of an example implementation of the example audience measurement device of FIG. 1.

FIG. 3 is a block diagram of an example implementation of the example behavior monitor of FIG. 2.

FIG. 4 is a block diagram of an example implementation of the example behavior tracker of FIG. 2.

FIG. 5 is a flowchart representation of example machine readable instructions that may be executed to implement the example behavior monitor of FIGS. 2 and/or 3.

FIG. 6 is a flowchart representation of example machine readable instructions that may be executed to implement the example behavior tracker of FIGS. 2 and/or 4.

FIG. 7 is an illustration of example packaging for an example media presentation device on which the example meter of FIGS. 1-4 may be implemented.

FIG. 8 is a flowchart representation of example machine readable instructions that may be executed to implement the example media presentation device of FIG. 7.

FIG. 9 is a block diagram of an example processing platform capable of executing the example machine readable instructions of FIG. 5 to implement the example behavior monitor of FIGS. 2 and/or 3, for executing the example machine readable instructions of FIG. 6 to implement the example behavior tracker of FIGS. 2 and/or 4, and/or for executing the example machine readable instructions of FIG. 8 to implement the example media presentation device of FIG. 7.

### DETAILED DESCRIPTION

In some audience measurement systems, people data is collected for a media exposure environment (e.g., a television room, a family room, a living room, a bar, a restaurant, an office space, a cafeteria, etc.) by capturing a series of images of the environment and analyzing the images to determine, for example, an identity of one or more persons present in the media exposure environment, an amount of people present in the media exposure environment during one or more times and/or periods of time, etc. The people data can be correlated with media identifying information corresponding to detected media to provide exposure data for that media. For example, an audience measurement entity (e.g., The Nielsen Company (US), LLC) can calculate ratings for a first piece of media (e.g., a television program) by correlating data collected from a plurality of panelist sites with the demographics of the panelist. For example, in each panelist site wherein the first piece of media is detected in the monitored environment at a first time, media identifying information for the first piece of media is correlated with presence information detected in the environment at the first time. The results from multiple panelist sites are combined and/or analyzed to provide ratings representative of exposure of a population as a whole.

Traditionally, such systems treat each detected person as present for purposes of calculating the exposure data (e.g., ratings) despite the fact that a first detected person may be paying little or no attention to the presentation of the media while a second detected person may be focused on (e.g., highly attentive too and/or interacting with) the presentation of the media.

Examples disclosed herein recognize that although a person may be detected as present in the media exposure environment, the presence of the person does not necessarily mean that the person is paying attention to (e.g., is engaged with) the media presentation. For example, a person detected as present in the media exposure environment may be reading a book or sleeping and, thus, not paying attention to a media presentation detected in the media exposure environment. Further, examples disclosed herein recognize that a first person may be more attentive to the detected presentation of the media than a second person. Examples disclosed herein monitor behavior (e.g., physical position, physical motion, creation of noise, etc.) of one or more audience members to, for example, measure attentiveness of the audience member(s) with respect to one or more media presentation devices. An example measure of attentiveness for an audience member provided by examples disclosed herein is referred to herein as an engagement level. In some examples disclosed herein, individual engagement levels of separate audience members (who may be physically located at a same specific exposure environment and/or at multiple different exposure environments) are combined, aggregated, statistically adjusted, and/or extrapolated to formulate a collective engagement level for an audience at one or more physical locations. In some examples disclosed herein, a person specific engagement level for each audience member with respect to particular media is calculated in real time (e.g., virtually simultaneously with) as a presentation device presents the particular media. In some examples, advertisements or other media are selected and/or presented to the audience based on one or more of the person specific engagement levels and/or the collective engagement level reflected by the monitored audience behavior.

To identify behavior and/or to determine a person specific engagement level of each person detected in a media exposure environment, examples disclosed herein utilize a multimodal sensor (e.g., an XBOX® Kinect® sensor) to capture image and/or audio data from a media exposure environment. Some examples disclosed herein analyze the image data and/or the audio data collected via the multimodal sensor to identify behavior and/or to measure person specific engagement level(s) and/or collective engagement level(s) for one or more persons detected in the media exposure environment during one or more periods of time. As described in greater detail below, examples disclosed herein utilize one or more types of information made available by the multimodal sensor to identify the behavior and/or develop the engagement level(s) for the detected person(s). Example types of information made available by the multimodal sensor include eye position and/or movement data, pose and/or posture data, audio volume level data, distance or depth data, and/or viewing angle data, etc. Examples disclosed herein may utilize additional or alternative types of information provided by the multimodal sensor and/or other sources of information to identify behavior(s) and/or to calculate and/or store the person specific and/or collective engagement levels of detected audience members. Further, some examples disclosed herein combine different types of information provided by the multimodal sensor and/or other sources of information to identify behavior(s) and/or to calculate and/or store a combined or collective engagement level for one or more groups.

Example methods, apparatus, and/or articles of manufacture select (e.g., in real time) one or more pieces of media (e.g., content and/or advertisement(s)), for presentation to an audience based on detected behavior(s) and/or engagement level(s) (e.g., person specific engagement level(s) and/or collective engagement level(s)) of the audience. For example, when a television programming stream has arrived at a designated commercial break time, examples disclosed herein select a first advertisement for presentation to the audience member(s) based on a current (e.g., an average over the last fifteen seconds) person specific engagement level (e.g., engagement of an individual) and/or a collective engagement level (e.g., engagement of a group of individuals). Some examples disclosed herein maintain (e.g., store and/or manage) a plurality of media collections from which media is selected based on the detected behavior(s) and/or engagement level(s). In some examples disclosed herein, the different media collections are ranked according to a tier structure in which a Tier One media collection is ranked above a Tier Two media collection, which is ranked above a Tier Three media collection, which is ranked above a Tier N media collection. The media collections of the higher ranked tiers (e.g., Tier One and Tier Two) are sometimes referred to herein as premium media collections.

In some examples disclosed herein, the premium media collections include media (e.g., advertisements) for which a different fee structure is arranged for the presentation of the media. For example, an entity (e.g., an advertiser) associated with a piece of media may be required to pay a premium fee (e.g., up front or retroactively) to have its media placed in a premium media collection (e.g., a Tier One media collection). In such instances, examples disclosed herein enable the premium paying entity to have its media presented to an audience that is likely paying attention to the corresponding media presentation device. The placement of media in the different media collections disclosed herein and/or the selection from the different media collections disclosed herein can be based on additional or alternative factors, detections, etc.

Example methods, apparatus, and/or articles of manufacture disclosed herein generate and/or enable generation of person specific and/or collective engagement ratings using the detected behavior(s) and/or engagement level(s) calculated for audience member(s). Traditional ratings that are generated using presence information are indications of exposure to media but are not indicative of whether audience member(s) actually paid attention to a media presentation (e.g., the person may be in a room with a television but may be on the phone or otherwise distracted). Conversely, some examples disclosed herein generate ratings indicative of how attentive the audience member(s) were to specific pieces of media (e.g., collectively and/or individually). Engagement ratings provided by examples disclosed herein can stand alone and/or be used to supplement traditional ratings. Compared to traditional ratings that are generated using only presence information, engagement ratings provided by examples disclosed herein are more granular from multiple perspectives. For example, engagement levels disclosed herein provide information regarding attentiveness of audience member(s) to particular portions or events of media, such as a particular scene, an appearance of a particular actor or actress, a particular song being played, a particular product being shown, etc. Thus, engagement levels disclosed herein are indicative of, for example, how attentive audience member(s) become and/or remain when a particular person, brand, or object is present in the media, and/or when a particular event or type of event occurs in media. As a result, more granular data (relative to data provided by previous presence-based systems) related to particular portions of media are provided by examples disclosed herein. Moreover, engagement levels disclosed herein provide specific information regarding attentiveness of individual audience members that can be identified via, for example, facial recognition. For example, a first (person specific) engagement level of a father of a household can be measured separately from a second (person specific) engagement level of a mother of a household using the same media. As a result, more granular data (relative to data provided by previous presence-based systems) related to particular people and/or demographics may be obtained by examples disclosed herein.

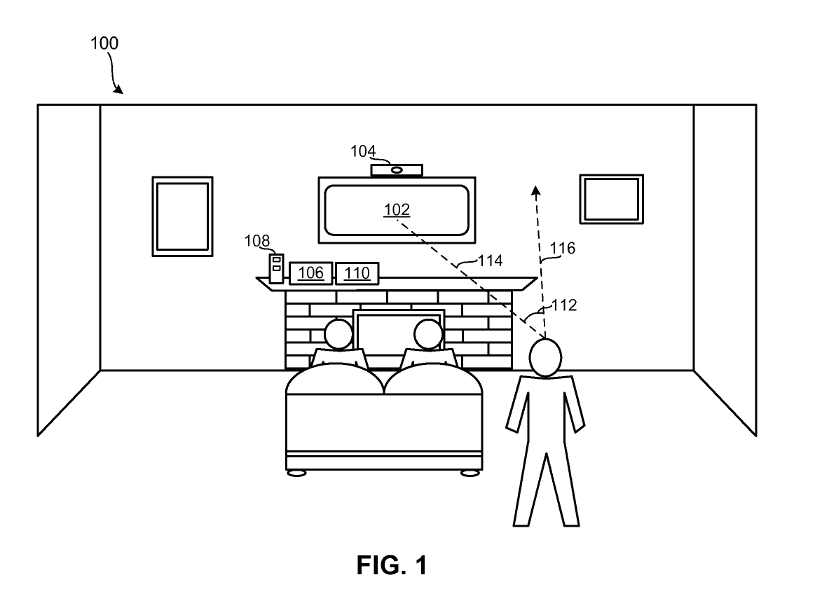

FIG. 1 is an illustration of an example media exposure environment 100 including a media presentation device 102, a multimodal sensor 104, and a meter 106 for collecting audience measurement data. In the illustrated example of FIG. 1, the media exposure environment 100 is a room of a household (e.g., a room in a home of a panelist such as the home of a “Nielsen family”) that has been statistically selected to develop television ratings data for a population/demographic of interest. In the illustrated example, one or more persons of the household have registered with an audience measurement entity (e.g., by agreeing to be a panelist) and have provided their demographic information to the audience measurement entity as part of a registration process to enable associating demographics with viewing activities (e.g., media exposure).

In some examples, the audience measurement entity provides the multimodal sensor 104 to the household. In some examples, the multimodal sensor 104 is a component of a media presentation system purchased by the household such as, for example, a camera of a video game system 108 (e.g., Microsoft® Kinect®) and/or piece(s) of equipment associated with a video game system (e.g., a Kinect® sensor). In such examples, the multimodal sensor 104 may be repurposed and/or data collected by the multimodal sensor 104 may be repurposed for audience measurement.

In the illustrated example of FIG. 1, the multimodal sensor 104 is placed above the information presentation device 102 at a position for capturing image and/or audio data of the environment 100. In some examples, the multimodal sensor 104 is positioned beneath or to a side of the information presentation device 102 (e.g., a television or other display). In some examples, the multimodal sensor 104 is integrated with the video game system 108. For example, the multimodal sensor 104 may collect image data (e.g., three-dimensional data and/or two-dimensional data) using one or more sensors for use with the video game system 108 and/or may also collect such image data for use by the meter 106. In some examples, the multimodal sensor 104 employs a first type of image sensor (e.g., a two-dimensional sensor) to obtain image data of a first type (e.g., two-dimensional data) and collects a second type of image data (e.g., three-dimensional data) from a second type of image sensor (e.g., a three-dimensional sensor). In some examples, only one type of sensor is provided by the video game system 108 and a second sensor is added by the audience measurement system.

In the example of FIG. 1, the meter 106 is a software meter provided for collecting and/or analyzing the data from, for example, the multimodal sensor 104 and other media identification data collected as explained below. In some examples, the meter 106 is installed in the video game system 108 (e.g., by being downloaded to the same from a network, by being installed at the time of manufacture, by being installed via a port (e.g., a universal serial bus (USB) from a jump drive provided by the audience measurement company, by being installed from a storage disc (e.g., an optical disc such as a BluRay disc, Digital Versatile Disc (DVD) or CD (compact Disk), or by some other installation approach). Executing the meter 106 on the panelist's equipment is advantageous in that it reduces the costs of installation by relieving the audience measurement entity of the need to supply hardware to the monitored household). In other examples, rather than installing the software meter 106 on the panelist's consumer electronics, the meter 106 is a dedicated audience measurement unit provided by the audience measurement entity. In such examples, the meter 106 may include its own housing, processor, memory and software to perform the desired audience measurement functions. In such examples, the meter 106 is adapted to communicate with the multimodal sensor 104 via a wired or wireless connection. In some such examples, the communications are affected via the panelist's consumer electronics (e.g., via a video game console). In other example, the multimodal sensor 104 is dedicated to audience measurement and, thus, no interaction with the consumer electronics owned by the panelist is involved.

The example audience measurement system of FIG. 1 can be implemented in additional and/or alternative types of environments such as, for example, a room in a non-statistically selected household, a theater, a restaurant, a tavern, a retail location, an arena, etc. For example, the environment may not be associated with a panelist of an audience measurement study, but instead may simply be an environment associated with a purchased XBOX® and/or Kinect® system. In some examples, the example audience measurement system of FIG. 1 is implemented, at least in part, in connection with additional and/or alternative types of media presentation devices such as, for example, a radio, a computer, a tablet, a cellular telephone, and/or any other communication device able to present media to one or more individuals.

In the illustrated example of FIG. 1, the presentation device 102 (e.g., a television) is coupled to a set-top box (STB) 110 that implements a digital video recorder (DVR) and a digital versatile disc (DVD) player. Alternatively, the DVR and/or DVD player may be separate from the STB 110. In some examples, the meter 106 of FIG. 1 is installed (e.g., downloaded to and executed on) and/or otherwise integrated with the STB 110. Moreover, the example meter 106 of FIG. 1 can be implemented in connection with additional and/or alternative types of media presentation devices such as, for example, a radio, a computer monitor, a video game console and/or any other communication device able to present content to one or more individuals via any past, present or future device(s), medium(s), and/or protocol(s) (e.g., broadcast television, analog television, digital television, satellite broadcast, Internet, cable, etc.).

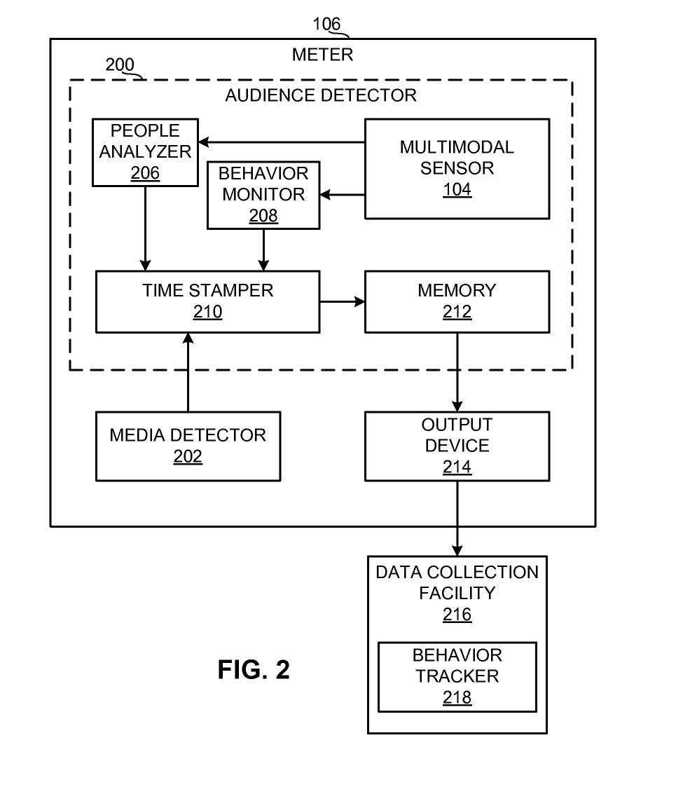

As described in detail below, the example meter 106 of FIG. 1 utilizes the multimodal sensor 104 to capture a plurality of time stamped frames of image data, depth data, and/or audio data from the environment 100. In example of FIG. 1, the multimodal sensor 104 of FIG. 1 is part of the video game system 108 (e.g., Microsoft® XBOX®, Microsoft® Kinect®). However, the example multimodal sensor 104 can be associated and/or integrated with the STB 110, associated and/or integrated with the presentation device 102, associated and/or integrated with a BlueRay® player located in the environment 100, or can be a standalone device (e.g., a Kinect® sensor bar, a dedicated audience measurement meter, etc.), and/or otherwise implemented. In some examples, the meter 106 is integrated in the STB 110 or is a separate standalone device and the multimodal sensor 104 is the Kinect® sensor or another sensing device. The example multimodal sensor 104 of FIG. 1 captures images within a fixed and/or dynamic field of view. To capture depth data, the example multimodal sensor 104 of FIG. 1 uses a laser or a laser array to project a dot pattern onto the environment 100. Depth data collected by the multimodal sensor 104 can be interpreted and/or processed based on the dot pattern and how the dot pattern lays onto objects of the environment 100. In the illustrated example of FIG. 1, the multimodal sensor 104 also captures two-dimensional image data via one or more cameras (e.g., infrared sensors) capturing images of the environment 100. In the illustrated example of FIG. 1, the multimodal sensor 104 also captures audio data via, for example, a directional microphone. As described in greater detail below, the example multimodal sensor 104 of FIG. 1 is capable of detecting some or all of eye position(s) and/or movement(s), skeletal profile(s), pose(s), posture(s), body position(s), person identit(ies), body type(s), etc. of the individual audience members. In some examples, the data detected via the multimodal sensor 104 is used to, for example, detect and/or react to a gesture, action, or movement taken by the corresponding audience member. The example multimodal sensor 104 of FIG. 1 is described in greater detail below in connection with FIG. 2.

As described in detail below in connection with FIG. 2, the example meter 106 of FIG. 1 also monitors the environment 100 to identify media being presented (e.g., displayed, played, etc.) by the presentation device 102 and/or other media presentation devices to which the audience is exposed. In some examples, identification(s) of media to which the audience is exposed are correlated with the presence information collected by the multimodal sensor 104 to generate exposure data for the media. In some examples, identification(s) of media to which the audience is exposed are correlated with behavior data (e.g., engagement levels) collected by the multimodal sensor 104 to additionally or alternatively generate engagement ratings for the media.

FIG. 2 is a block diagram of an example implementation of the example meter 106 of FIG. 1. The example meter 106 of FIG. 2 includes an audience detector 200 to develop audience composition information regarding, for example, the audience members of FIG. 1. The example meter 106 of FIG. 2 also includes a media detector 202 to collect media information regarding, for example, media presented in the environment 100 of FIG. 1. The example multimodal sensor 104 of FIG. 2 includes a three-dimensional sensor and a two-dimensional sensor. The example meter 106 may additionally or alternatively receive three-dimensional data and/or two-dimensional data representative of the environment 100 from different source(s). For example, the meter 106 may receive three-dimensional data from the multimodal sensor 104 and two-dimensional data from a different component. Alternatively, the meter 106 may receive two-dimensional data from the multimodal sensor 104 and three-dimensional data from a different component.

In some examples, to capture three-dimensional data, the multimodal sensor 104 projects an array or grid of dots (e.g., via one or more lasers) onto objects of the environment 100. The dots of the array projected by the example multimodal sensor 104 have respective x-axis coordinates and y-axis coordinates and/or some derivation thereof. The example multimodal sensor 104 of FIG. 2 uses feedback received in connection with the dot array to calculate depth values associated with different dots projected onto the environment 100. Thus, the example multimodal sensor 104 generates a plurality of data points. Each such data point has a first component representative of an x-axis position in the environment 100, a second component representative of a y-axis position in the environment 100, and a third component representative of a z-axis position in the environment 100. As used herein, the x-axis position of an object is referred to as a horizontal position, the y-axis position of the object is referred to as a vertical position, and the z-axis position of the object is referred to as a depth position relative to the multimodal sensor 104. The example multimodal sensor 104 of FIG. 2 may utilize additional or alternative type(s) of three-dimensional sensor(s) to capture three-dimensional data representative of the environment 100.

While the example multimodal sensor 104 implements a laser to projects the plurality grid points onto the environment 100 to capture three-dimensional data, the example multimodal sensor 104 of FIG. 2 also implements an image capturing device, such as a camera, that captures two-dimensional image data representative of the environment 100. In some examples, the image capturing device includes an infrared imager and/or a charge coupled device (CCD) camera. In some examples, the multimodal sensor 104 only captures data when the information presentation device 102 is in an “on” state and/or when the media detector 202 determines that media is being presented in the environment 100 of FIG. 1. The example multimodal sensor 104 of FIG. 2 may also include one or more additional sensors to capture additional or alternative types of data associated with the environment 100.

Further, the example multimodal sensor 104 of FIG. 2 includes a directional microphone array capable of detecting audio in certain patterns or directions in the media exposure environment 100. In some examples, the multimodal sensor 104 is implemented at least in part by a Microsoft® Kinect® sensor.

The example audience detector 200 of FIG. 2 includes a people analyzer 206, a behavior monitor 208, a time stamper 210, and a memory 212. In the illustrated example of FIG. 2, data obtained by the multimodal sensor 104 of FIG. 2, such as depth data, two-dimensional image data, and/or audio data is conveyed to the people analyzer 206. The example people analyzer 206 of FIG. 2 generates a people count or tally representative of a number of people in the environment 100 for a frame of captured image data. The rate at which the example people analyzer 206 generates people counts is configurable. In the illustrated example of FIG. 2, the example people analyzer 206 instructs the example multimodal sensor 104 to capture data (e.g., three-dimensional and/or two-dimensional data) representative of the environment 100 every five seconds. However, the example people analyzer 206 can receive and/or analyze data at any suitable rate.

The example people analyzer 206 of FIG. 2 determines how many people appear in a frame in any suitable manner using any suitable technique. For example, the people analyzer 206 of FIG. 2 recognizes a general shape of a human body and/or a human body part, such as a head and/or torso. Additionally or alternatively, the example people analyzer 206 of FIG. 2 may count a number of “blobs” that appear in the frame and count each distinct blob as a person. Recognizing human shapes and counting “blobs” are illustrative examples and the people analyzer 206 of FIG. 2 can count people using any number of additional and/or alternative techniques. An example manner of counting people is described by Ramaswamy et al. in U.S. patent application Ser. No. 10/538,483, filed on Dec. 11, 2002, now U.S. Pat. No. 7,203,338, which is hereby incorporated herein by reference in its entirety. In some examples, to determine the number of detected people in a room, the example people analyzer 206 of FIG. 2 also tracks a position (e.g., an X-Y coordinate) of each detected person.

Additionally, the example people analyzer 206 of FIG. 2 executes a facial recognition procedure such that people captured in the frames can be individually identified. In some examples, the audience detector 200 may have additional or alternative methods and/or components to identify people in the frames. For example, the audience detector 200 of FIG. 2 can implement a feedback system to which the members of the audience provide (e.g., actively and/or passively) identification to the meter 106. To identify people in the frames, the example people analyzer 206 includes or has access to a collection (e.g., stored in a database) of facial signatures (e.g., image vectors). Each facial signature of the illustrated example corresponds to a person having a known identity to the people analyzer 206. The collection includes an identifier (ID) for each known facial signature that corresponds to a known person. For example, in reference to FIG. 1, the collection of facial signatures may correspond to frequent visitors and/or members of the household associated with the room 100. The example people analyzer 206 of FIG. 2 analyzes one or more regions of a frame thought to correspond to a human face and develops a pattern or map for the region(s) (e.g., using the depth data provided by the multimodal sensor 104). The pattern or map of the region represents a facial signature of the detected human face. In some examples, the pattern or map is mathematically represented by one or more vectors. The example people analyzer 206 of FIG. 2 compares the detected facial signature to entries of the facial signature collection. When a match is found, the example people analyzer 206 has successfully identified at least one person in the frame. In such instances, the example people analyzer 206 of FIG. 2 records (e.g., in a memory address accessible to the people analyzer 206) the ID associated with the matching facial signature of the collection. When a match is not found, the example people analyzer 206 of FIG. 2 retries the comparison or prompts the audience for information that can be added to the collection of known facial signatures for the unmatched face. More than one signature may correspond to the same face (i.e., the face of the same person). For example, a person may have one facial signature when wearing glasses and another when not wearing glasses. A person may have one facial signature with a beard, and another when cleanly shaven.

Each entry of the collection of known people used by the example people analyzer 206 of FIG. 2 also includes a type for the corresponding known person. For example, the entries of the collection may indicate that a first known person is a child of a certain age and/or age range and that a second known person is an adult of a certain age and/or age range. In instances in which the example people analyzer 206 of FIG. 2 is unable to determine a specific identity of a detected person, the example people analyzer 206 of FIG. 2 estimates a type for the unrecognized person(s) detected in the exposure environment 100. For example, the people analyzer 206 of FIG. 2 estimates that a first unrecognized person is a child, that a second unrecognized person is an adult, and that a third unrecognized person is a teenager. The example people analyzer 206 of FIG. 2 bases these estimations on any suitable factor(s) such as, for example, height, head size, body proportion(s), etc.

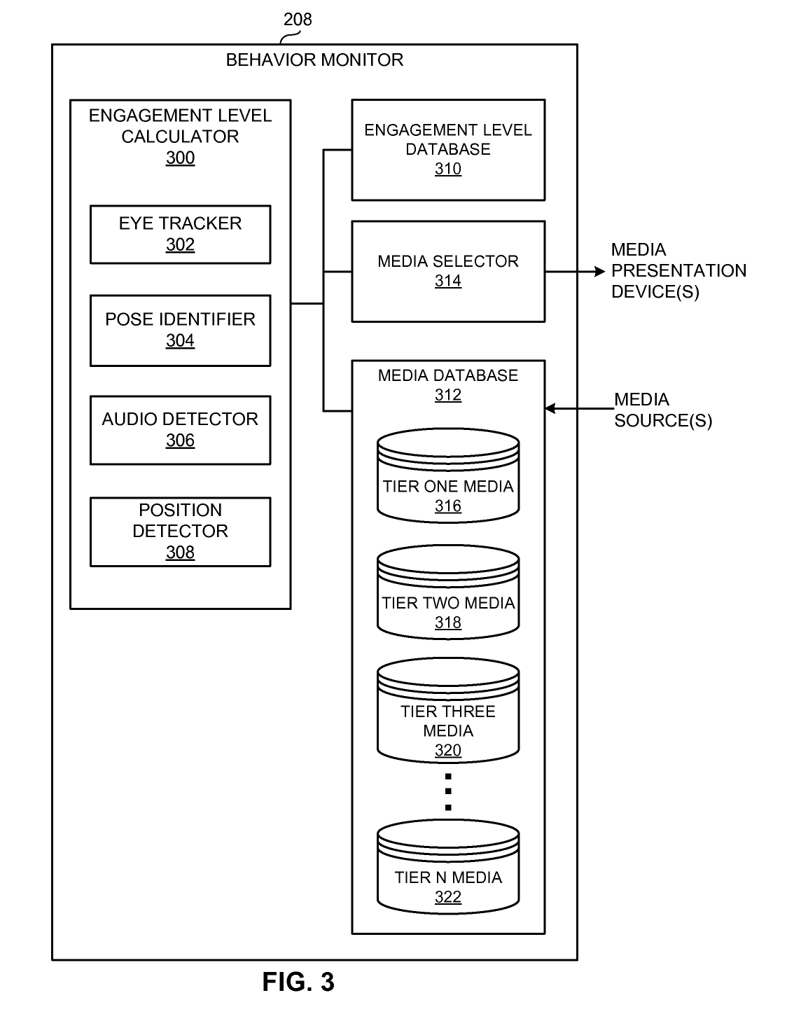

In the illustrated example, data obtained by the multimodal sensor 104 of FIG. 2 is also conveyed to the behavior monitor 208. As described in greater detail below in connection with FIG. 3, the data conveyed to the example behavior monitor 208 of FIG. 2 is used by examples disclosed herein to identify behavior(s) and/or generate engagement level(s) for people appearing in the environment 100. As described in detail below in connection with FIG. 3, the engagement level(s) are used by examples disclosed herein to select (e.g., in real time) a media collection based on current behavior(s) and/or attentiveness level(s) of the audience.

The example people analyzer 206 of FIG. 2 outputs the calculated tallies, identification information, person type estimations for unrecognized person(s), and/or corresponding image frames to the time stamper 210. Similarly, the example behavior monitor 208 outputs data (e.g., calculated behavior(s), engagement levels, media selections, etc.) to the time stamper 210. The time stamper 210 of the illustrated example includes a clock and a calendar. The example time stamper 210 associates a time period (e.g., 1:00 a.m. Central Standard Time (CST) to 1:01 a.m. CST) and date (e.g., Jan. 1, 2012) with each calculated people count, identifier, frame, behavior, engagement level, media selection, etc., by, for example, appending the period of time and data information to an end of the data. A data package (e.g., the people count, the time stamp, the identifier(s), the date and time, the engagement levels, the behavior, the image data, etc.) is stored in the memory 212.

The memory 212 may include a volatile memory (e.g., Synchronous Dynamic Random Access Memory (SDRAM), Dynamic Random Access Memory (DRAM), RAMBUS Dynamic Random Access Memory (RDRAM, etc.) and/or a non-volatile memory (e.g., flash memory). The memory 212 may include one or more double data rate (DDR) memories, such as DDR, DDR2, DDR3, mobile DDR (mDDR), etc. The memory 212 may additionally or alternatively include one or more mass storage devices such as, for example, hard drive disk(s), compact disk drive(s), digital versatile disk drive(s), etc. When the example meter 106 is integrated into, for example the video game system 108 of FIG. 1, the meter 106 may utilize memory of the video game system 108 to store information such as, for example, the people counts, the image data, the engagement levels, etc.

The example time stamper 210 of FIG. 2 also receives data from the example media detector 202. The example media detector 202 of FIG. 2 detects presentation(s) of media in the media exposure environment 100 and/or collects identification information associated with the detected presentation(s). For example, the media detector 202, which may be in wired and/or wireless communication with the presentation device (e.g., television) 102, the multimodal sensor 104, the video game system 108, the STB 110, and/or any other component(s) of FIG. 1, can identify a presentation time and a source of a presentation. The presentation time and the source identification data may be utilized to identify the program by, for example, cross-referencing a program guide configured, for example, as a look up table. In such instances, the source identification data may be, for example, the identity of a channel (e.g., obtained by monitoring a tuner of the STB 110 of FIG. 1 or a digital selection made via a remote control signal) currently being presented on the information presentation device 102.

Additionally or alternatively, the example media detector 202 can identify the presentation by detecting codes (e.g., watermarks) embedded with or otherwise conveyed (e.g., broadcast) with media being presented via the STB 110 and/or the information presentation device 102. As used herein, a code is an identifier that is transmitted with the media for the purpose of identifying and/or for tuning to (e.g., via a packet identifier header and/or other data used to tune or select packets in a multiplexed stream of packets) the corresponding media. Codes may be carried in the audio, in the video, in metadata, in a vertical blanking interval, in a program guide, in content data, or in any other portion of the media and/or the signal carrying the media. In the illustrated example, the media detector 202 extracts the codes from the media. In some examples, the media detector 202 may collect samples of the media and export the samples to a remote site for detection of the code(s).

Additionally or alternatively, the media detector 202 can collect a signature representative of a portion of the media. As used herein, a signature is a representation of some characteristic of signal(s) carrying or representing one or more aspects of the media (e.g., a frequency spectrum of an audio signal). Signatures may be thought of as fingerprints of the media. Collected signature(s) can be compared against a collection of reference signatures of known media to identify the tuned media. In some examples, the signature(s) are generated by the media detector 202. Additionally or alternatively, the media detector 202 may collect samples of the media and export the samples to a remote site for generation of the signature(s). In the example of FIG. 2, irrespective of the manner in which the media of the presentation is identified (e.g., based on tuning data, metadata, codes, watermarks, and/or signatures), the media identification information is time stamped by the time stamper 210 and stored in the memory 212.

In the illustrated example of FIG. 2, the output device 214 periodically and/or aperiodically exports data (e.g., media identification information, audience identification information, etc.) from the memory 214 to a data collection facility 216 via a network (e.g., a local-area network, a wide-area network, a metropolitan-area network, the Internet, a digital subscriber line (DSL) network, a cable network, a power line network, a wireless communication network, a wireless mobile phone network, a Wi-Fi network, etc.). In some examples, the example meter 106 utilizes the communication abilities (e.g., network connections) of the video game system 108 to convey information to, for example, the data collection facility 216. In the illustrated example of FIG. 2, the data collection facility 216 is managed and/or owned by an audience measurement entity (e.g., The Nielsen Company (US), LLC). The audience measurement entity associated with the example data collection facility 216 of FIG. 2 utilizes the people tallies generated by the people analyzer 206 and/or the personal identifiers generated by the people analyzer 206 in conjunction with the media identifying data collected by the media detector 202 to generate exposure information. The information from many panelist locations may be compiled and analyzed to generate ratings representative of media exposure by one or more populations of interest.

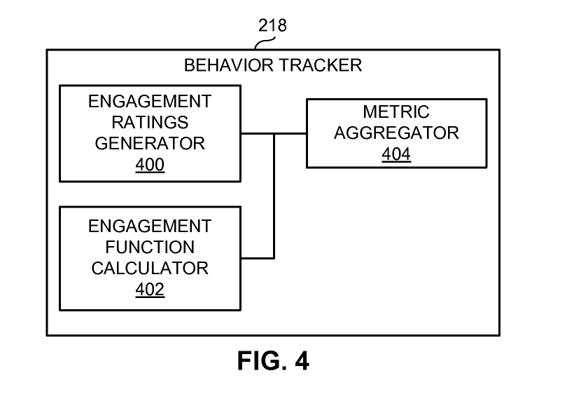

The example data collection facility 216 also employs an example behavior tracker 218 to analyze the behavior/engagement level information generated by the example behavior monitor 208. As described in greater detail below in connection with FIG. 4, the example behavior tracker 218 uses the behavior/engagement level information to, for example, generate engagement level ratings for media identified by the media detector 202. As described in greater detail below in connection with FIG. 4, in some examples, the example behavior tracker 218 uses the engagement level information to determine whether a retroactive fee is due to a service provider from an advertiser due to a certain engagement level existing at a time of presentation of content of the advertiser.

Alternatively, analysis of the data (e.g., data generated by the people analyzer 206, the behavior monitor 208, and/or the media detector 202) may be performed locally (e.g., by the example meter 106 of FIG. 2) and exported via a network or the like to a data collection facility (e.g., the example data collection facility 216 of FIG. 2) for further processing. For example, the amount of people (e.g., as counted by the example people analyzer 206) and/or engagement level(s) (e.g., as calculated by the example behavior monitor 208) in the exposure environment 100 at a time (e.g., as indicated by the time stamper 210) in which a sporting event (e.g., as identified by the media detector 202) was presented by the presentation device 102 can be used in a exposure calculation and/or engagement calculation for the sporting event. In some examples, additional information (e.g., demographic data associated with one or more people identified by the people analyzer 206, geographic data, etc.) is correlated with the exposure information and/or the engagement information by the audience measurement entity associated with the data collection facility 216 to expand the usefulness of the data collected by the example meter 106 of FIGS. 1 and/or 2. The example data collection facility 216 of the illustrated example compiles data from a plurality of monitored exposure environments (e.g., other households, sports arenas, bars, restaurants, amusement parks, transportation environments, retail locations, etc.) and analyzes the data to generate exposure ratings and/or engagement ratings for geographic areas and/or demographic sets of interest.

While an example manner of implementing the meter 106 of FIG. 1 has been illustrated in FIG. 2, one or more of the elements, processes and/or devices illustrated in FIG. 2 may be combined, divided, re-arranged, omitted, eliminated and/or implemented in any other way. Further, the example audience detector 200, the example media detector 202, the example multimodal sensor 104, the example people analyzer 206, the example behavior monitor 208, the example time stamper 210, the example output device 214, the example behavior tracker 218, and/or, more generally, the example meter 106 of FIG. 2 may be implemented by hardware, software, firmware and/or any combination of hardware, software and/or firmware. Thus, for example, any of the example audience detector 200, the example media detector 202, the example multimodal sensor 104, the example people analyzer 206, the behavior monitor 208, the example time stamper 210, the example output device 214, the example behavior tracker 218, and/or, more generally, the example meter 106 of FIG. 2 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example audience detector 200, the example media detector 202, the example multimodal sensor 104, the example people analyzer 206, the behavior monitor 208, the example time stamper 210, the example output device 214, the example behavior tracker 218, and/or, more generally, the example meter 106 of FIG. 2 are hereby expressly defined to include a tangible computer readable storage medium such as a storage device (e.g., memory) or an optical storage disc (e.g., a DVD, a CD, a Bluray disc) storing the software and/or firmware. Further still, the example meter 106 of FIG. 2 may include one or more elements, processes and/or devices in addition to, or instead of, those illustrated in FIG. 2, and/or may include more than one of any or all of the illustrated elements, processes and devices.

FIG. 3 is a block diagram of an example implementation of the example behavior monitor 208 of FIG. 2. As described above in connection with FIG. 2, the example behavior monitor 208 of FIG. 3 receives data from the multimodal sensor 104. The example behavior monitor 208 of FIG. 3 processes and/or interprets the data provided by the multimodal sensor 104 to analyze one or more aspects of behavior exhibited by one or more members of the audience of FIG. 1. In particular, the example behavior monitor 208 of FIG. 3 includes an engagement level calculator 300 that uses indications of certain behaviors detected by the multimodal sensor 104 to generate an attentiveness metric (e.g., engagement level) for each detected audience member. In the illustrated example, the engagement level calculated by the engagement level calculator 300 is indicative of how attentive the respective audience member is to a media presentation device, such as the presentation device 102 of FIG. 1. The metric generated by the example engagement level calculator 300 of FIG. 3 is any suitable type of value such as, for example, a numeric score based on a scale, a percentage, a categorization, one of a plurality of levels defined by respective thresholds, etc. In some examples, the metric generated by the example engagement level calculator 300 of FIG. 3 is an aggregate score or percentage (e.g., a weighted average) formed by combining a plurality of individual engagement level scores or percentages based on different data and/or detections (e.g., to form one or more collective engagement levels).

In the illustrated example of FIG. 3, the engagement level calculator 300 includes an eye tracker 302 to utilize eye position and/or movement data provided by the multimodal sensor 104. The example eye tracker 302 uses the eye position and/or movement data to determine or estimate whether, for example, a detected audience member is looking in a direction of the presentation device 102, whether the audience member is looking away from the presentation device 102, whether the audience member is looking in the general vicinity of the presentation device 102, or otherwise engaged or disengaged from the presentation device 102. That is, the example eye tracker 302 categorizes how closely a gaze of the detected audience member is to the presentation device 102 based on, for example, an angular difference (e.g., an angle of a certain degree) between a direction of the detected gaze and a direct line of sight between the audience member and the presentation device 102. FIG. 1 illustrates an example detection of the example eye tracker 302 of FIG. 3. In the example of FIG. 1, an angular difference 112 is detected by the eye tracker 302 of FIG. 3. In particular, the example eye tracker 302 of FIG. 3 determines a direct line of sight 114 between a first member of the audience and the presentation device 102. Further, the example eye tracker 302 of FIG. 3 determines a current gaze direction 116 of the first audience member. The example eye tracker 302 calculates the angular difference 112 between the direct line of sight 114 and the current gaze direction 116 by, for example, determining one of more angles between the two lines 114 and 116. While the example of FIG. 1 includes one angle 112 between the direct line of sight 114 and the gaze direction 116 in a first dimension, in some examples the eye tracker 302 of FIG. 3 calculates a plurality of angles between a first vector representative of the direct line of sight 114 and a second vector representative of the gaze direction 116. In such instances, the example eye tracker 302 includes more than one dimension in the calculation of the difference between the direct line of sight 114 and the gaze direction 116.

In some examples, the eye tracker 302 calculates a likelihood that the respective audience member is looking at the presentation device 102 based on, for example, the calculated difference between the direct line of sight 114 and the gaze direction 116. For example, the eye tracker 302 of FIG. 3 compares the calculated difference to one or more thresholds to select one of a plurality of categories (e.g., looking away, looking in the general vicinity of the presentation device 102, looking directly at the presentation device 102, etc.). In some examples, the eye tracker 302 translates the calculated difference (e.g., degrees) between the direct line of sight 114 and the gaze direction 116 into a numerical representation of a likelihood of engagement. For example, the eye tracker 302 of FIG. 3 determines a percentage indicative of a likelihood that the audience member is engaged with the presentation device 102 and/or indicative of a level of engagement of the audience member. In such instances, higher percentages indicate proportionally higher levels of attention or engagement.

In some examples, the example eye tracker 302 combines measurements and/or calculations taken in connection with a plurality of frames (e.g., consecutive frames). For example, the likelihoods of engagement calculated by the example eye tracker 302 of FIG. 3 can be combined (e.g., averaged) for a period of time spanning the plurality of frames to generate a collective likelihood that the audience member looked at the television for the period of time. In some examples, the likelihoods calculated by the example eye tracker 302 of FIG. 3 are translated into respective percentages indicative of how likely the corresponding audience member(s) are looking at the presentation device 102 over the corresponding period(s) of time. Additionally or alternatively, the example eye tracker 302 of FIG. 3 combines consecutive periods of time and the respective likelihoods to determine whether the audience member(s) were looking at the presentation device 102 through consecutive frames. Detecting that the audience member(s) likely viewed the presentation device 102 through multiple consecutive frames may indicate a higher level of engagement with the television, as opposed to indications that the audience member frequently switched from looking at the presentation device 102 and looking away from the presentation device 102. For example, the eye tracker 302 may calculate a percentage (e.g., based on the angular difference detection described above) representative of a likelihood of engagement for each of twenty consecutive frames. In some examples, the eye tracker 302 calculates an average of the twenty percentages and compares the average to one or more thresholds, each indicative of a level of engagement. Depending on the comparison of the average to the one or more thresholds, the example eye tracker 302 determines a likelihood or categorization of the level of engagement of the corresponding audience member for the period of time corresponding to the twenty frames.

In some examples, the likelihood(s) and/or percentage(s) of engagement generated by the eye tracker 302 are based on one or more tables having a plurality of threshold values and corresponding scores. For example, the eye tracker 302 of FIG. 3 references the following lookup table to generate an engagement score for a particular measurement and/or eye position detection.

TABLE 1

| Angular Difference | Engagement Score |
|---|---|
| Eye Position Not Detected | 1 |
| >45 Degrees | 4 |
| 11°-45° | 7 |
| 0°-10° | 10 |

As shown in Table 1, an audience member is assigned a greater engagement score when the audience member is more closely at the presentation device 102. The angular difference entries and the engagement scores of Table 1 are examples and additional or alternative angular difference ranges and/or engagement scores are possible. Further, while the engagement scores of Table 1 are whole numbers, additional or alternative types of scores are possible, such as percentages. Further, in some examples, the precise angular difference detected by the example eye tracker 302 can be translated into a specific engagement score using any suitable algorithm or equation. In other words, the example eye tracker 302 may directly translated an angular difference and/or any other measurement value into an engagement score in addition to or in lieu of using a range of potential measurements (e.g., angular differences) to assign a score to the corresponding audience member.

In the illustrated example of FIG. 1, the engagement calculator 300 includes a pose identifier 304 to utilize data provided by the multimodal sensor 104 related to a skeletal framework or profile of one or more members of the audience, as generated by the depth data provided by the multimodal sensor 104 of FIG. 2. The example pose identifier 304 uses the skeletal profile to determine or estimate a pose (e.g., facing away, facing towards, looking sideways, lying down, sitting down, standing up, etc.) and/or posture (e.g., hunched over, sitting, upright, reclined, standing, etc.) of a detected audience member. Poses that indicate a faced away position from the television (e.g., a bowed head, looking away, etc.) generally indicate lower levels of engagement. Upright postures (e.g., on the edge of a seat) indicate more engagement with the media. The example pose identifier 304 of FIG. 3 also detects changes in pose and/or posture, which may be indicative of more or less engagement with the media (e.g., depending on a beginning and ending pose and/or posture).

Additionally or alternatively, the example pose identifier 304 of FIG. 3 determines whether the audience member is making a gesture reflecting an emotional state, a gesture intended for a gaming control technique, a gesture to control the presentation device 102, and/or identifies the gesture. Gestures indicating emotional reaction (e.g., raised hands, fist pumping, etc.) indicate greater levels of engagement with the media. The example engagement level calculator 300 of FIG. 3 determines that different poses, postures, and/or gestures identified by the example pose identifier 304 are more or less indicative of engagement with, for example, a current media presentation via the presentation device 102 by, for example, comparing the identified pose, posture, and/or gesture to a look up table having engagement scores assigned to the corresponding pose, posture, and/or gesture. An example of such a lookup table is shown below as Table 2. Using this information, the example pose identifier 304 calculates a likelihood that the corresponding audience member is engaged with the presentation device 102 for each frame (e.g., or some subset of frames) of the media. Similar to the eye tracker 302, the example pose identifier can combine the individual likelihoods of engagement for multiple frames and/or audience members to generate a collective likelihood for one or more periods of time and/or can calculate a percentage of time in which poses, postures, and/or gestures indicate the audience member(s) (collectively and/or individually) are engaged with the media.

TABLE 2

| Pose, Posture or Gesture | Engagement Score |
|---|---|
| Facing Presentation | 8 |
| Device - Standing | |
| Facing Presentation | 9 |
| Device - Sitting | |
| Not Facing Presentation | 4 |
| Device - Standing | |
| Not Facing Presentation | 5 |
| Device - Sitting | |
| Lying Down | 6 |
| Sitting Down | 5 |
| Standing | 4 |
| Reclined | 7 |
| Sitting Upright | 8 |
| On Edge of Seat | 10 |
| Making Gesture Related to | 10 |
| Video Game System | |
| Making Gesture Related to | 10 |
| Feedback System | |
| Making Emotional Gesture | 9 |
| Making Emotional Reaction | 9 |
| Gesture | |
| Hunched Over | 5 |
| Head Bowed | 4 |
| Asleep | 0 |

As shown in the example of Table 2, the example pose identifier 304 of FIG. 3 assigns higher engagement scores for certain detections than others. The example scores and detections of Table 2 are examples and additional or alternative detection(s) and/or engagement score(s) are possible. Further, while the engagement scores of Table 2 are whole numbers, additional or alternative types of scores are possible, such as percentages.

In the illustrated example of FIG. 3, the engagement level calculator 300 includes an audio detector 306 to utilize audio information provided by the multimodal sensor 104. The example audio detector 306 of FIG. 3 uses, for example, directional audio information provided by a microphone array of the multimodal sensor 104 to determine a likelihood that the audience member is engaged with the media presentation. For example, a person that is speaking loudly or yelling (e.g., toward the presentation device 102) may be interpreted by the audio detector 306 as more likely to be engaged with the presentation device 102 than someone speaking at a lower volume (e.g., because that person is likely having a conversation).

Further, speaking in a direction of the presentation device 102 (e.g., as detected by the directional microphone array of the multimodal sensor 104) may be indicative of a higher level of engagement. Further, when speech is detected but only one audience member is present, the example audio detector 306 may credit the audience member with a higher level engagement. Further, when the multimodal sensor 104 is located proximate to the presentation device 102, if the multimodal sensor 104 detects a higher (e.g., above a threshold) volume from a person, the example audio detector 306 of FIG. 3 determines that the person is more likely facing the presentation device 102. This determination may be additionally or alternatively made by combining data from the camera of a video sensor.

In some examples, the spoken words from the audience are detected and compared to the context and/or content of the media (e.g., to the audio track) to detect correlation (e.g., word repeats, actors names, show titles, etc.) indicating engagement with the media. A word related to the context and/or content of the media is referred to herein as an ‘engaged’ word.

The example audio detector 306 uses the audio information to calculate an engagement likelihood for frames of the media. Similar to the eye tracker 302 and/or the pose identifier 304, the example audio detector 306 can combine individual ones of the calculated likelihoods to form a collective likelihood for one or more periods of time and/or can calculate a percentage of time in which voice or audio signals indicate the audience member(s) are paying attention to the media.

TABLE 3

| Audio Detection | Engagement Score |
|---|---|
| Speaking Loudly (>70 dB) | 8 |
| Speaking Softly (<50 dB) | 3 |
| Speaking Regularly (50-70 dB) | 6 |
| Speaking While Alone | 7 |
| Speaking in Direction of | 8 |
| Presentation Device | |
| Speaking Away from | 4 |
| Presentation Device | |
| Engaged Word Detected | 10 |

As shown in the example of Table 3, the example audio detector 306 of FIG. 3 assigns higher engagement scores for certain detections than others. The example scores and detections of Table 3 are examples and additional or alternative detection(s) and/or engagement score(s) are possible. Further, while the engagement scores of Table 3 are whole numbers, additional or alternative types of scores are possible, such as percentages.

In the illustrated example of FIG. 3, the engagement level calculator 300 includes a position detector 308, which uses data provided by the multimodal sensor 104 (e.g., the depth data) to determine a position of a detected audience member relative to the multimodal sensor 104 and, thus, the presentation device 102. For example, the position detector 308 of FIG. 3 uses depth information (e.g., provided by the dot pattern information generated by the laser of the multimodal sensor 104) to calculate an approximate distance (e.g., away from the multimodal sensor 104 and, thus, the presentation device 102 located adjacent or integral with the multimodal sensor 104) at which an audience member is detected. The example position detector 308 of FIG. 3 treats closer audience members as more likely to be engaged with the presentation device 102 than audience members located farther away from the presentation device 102.

Additionally, the example position detector 308 of FIG. 3 uses data provided by the multimodal sensor 104 to determine a viewing angle associated with each audience member for one or more frames. The example position detector 308 of FIG. 3 interprets a person directly in front of the presentation device 102 as more likely to be engaged with the presentation device 102 than a person located to a side of the presentation device 102. The example position detector 308 of FIG. 3 uses the position information (e.g., depth and/or viewing angle) to calculate a likelihood that the corresponding audience member is engaged with the presentation device 102. The example position detector 308 of FIG. 3 takes note of a seating change or position change of an audience member from a side position to a front position as indicating an increase in engagement. Conversely, the example position detector 308 takes note of a seating change or position change of an audience member from a front position to a side position as indicating a decrease in engagement. Similar to the eye tracker 302, the pose identifier 304, and/or the audio detector 306, the example position detector 308 of FIG. 3 can combine the calculated likelihoods of different (e.g., consecutive) frames to form a collective likelihood that the audience member is engaged with the presentation device 102 and/or can calculate a percentage of time in which position data indicates the audience member(s) are paying attention to the content.

TABLE 4

| Distance or Viewing Angle | Engagement Score |
|---|---|
| 0-5 Feet Away From | 9 |
| Presentation Device | |
| 6-8 Feet Away From | 7 |
| Presentation Device | |
| 8-12 Feet Away From | 4 |
| Presentation Device | |
| >12 Feet Away From | 2 |
| Presentation Device | |
| Directly In Front of | 9 |
| Presentation Device | |
| (Viewing Angle = 0°-10°) | |
| Slightly Askew From | 7 |
| Presentation Device | |
| (Viewing Angle = 11°-30°) | |
| Side Viewing Presentation | 4 |
| Device | |
| (Viewing Angle = 31°-60°) | |
| Outside of Viewing Range | 1 |
| (Viewing Angle >60°) | |

As shown in the example of Table 4, the example position detector 308 of FIG. 3 assigns higher engagement scores for certain detections than others. The example scores and detections of Table 4 are examples and additional or alternative detection(s) and/or engagement score(s) are possible. Further, while the engagement scores of Table 4 are whole numbers, additional or alternative types of scores are possible, such as percentages.

In some examples, the engagement level calculator 300 bases individual ones of the engagement likelihoods and/or scores on particular combinations of detections from different ones of the eye tracker 302, the pose identifier 304, the audio detector 306, the position detector 308, and/or other component(s). For example, the engagement level calculator 300 may generate a particular (e.g., very high) engagement likelihood and/or score for a combination of the pose identifier 304 detecting a person making a gesture known to be associated with the video game system 108 and the position detector 308 determining that the person is located directly in front of the presentation 102 and four (4) feet away from the presentation device. Further, eye movement and/or position data generated by the eye tracker 302 can be combined with skeletal profile information from the pose identifier 304 to determine whether, for example, a detected person is lying down and has his or her eyes closed. In such instances, the example engagement level calculator 300 of FIG. 3 determines that the audience member is likely sleeping and, thus, would be assigned a low engagement level (e.g., one (1) on a scale of one (1) to ten (10)). Additionally or alternatively, a lack of eye data from the eye tracker 302 at a position indicated by the position detector 308 as including a person is indicative of a person facing away from the presentation device 102. In such instances, the example engagement level calculator 300 of FIG. 3 assigns the audience member a low engagement level (e.g., three (3) on a scale of one (1) to ten (10)). Additionally or alternatively, the pose identifier 304 indicating that an audience member is sitting, combined with the position detector 308 indicating that the audience member is directly in front of the presentation device 102, combined with the audio detector 306 not detecting human voices, strongly indicates that the audience member is engaged with the presentation device 102. In such instances, the example engagement level calculator 300 of FIG. 3 assigns the attentive audience member a high engagement level (e.g., nine (9) on a scale of one (1) to ten (10)). Additionally or alternatively, the position indicator 308 detecting a change in position, combined with an indication that an audience member is facing the presentation device 102 after changing position indicates that the audience member is engaged with the presentation device 102. In such instances, the example engagement level calculator 300 of FIG. 3 assigns the attentive audience member a high engagement level (e.g., eight (8) on a scale of one (1) to ten (10)). In some examples, the engagement level calculator 300 only assigns a definitive engagement level (e.g., ten (10) on a scale of one (1) to ten (10)) when the engagement level is based on active input received from the audience member that indicates that the audience member is paying attention to the media presentation.

Further, in some examples, the engagement level calculator 300 combines or aggregates the individual likelihoods and/or engagement scores generated by the eye tracker 302, the pose identifier 304, the audio detector 306, and/or the position detector 308 to form an aggregated likelihood for a frame or a group of frames of media (e.g. as identified by the media detector 202 of FIG. 2). The aggregated likelihood and/or percentage is used by the example engagement level calculator 300 of FIG. 3 to assign an engagement level to the corresponding frames and/or group of frames. In some examples, the engagement level calculator 300 averages the generated likelihoods and/or scores to generate the aggregate engagement score(s). Alternatively, the example engagement level calculator 300 calculates a weighted average of the generated likelihoods and/or scores to generate the aggregate engagement score(s). In such instances, configurable weights are assigned to different ones of the detections associated with the eye tracker 302, the pose identifier 304, the audio detector 306, and/or the position detector 308.

Moreover, the example engagement level calculator 300 of FIG. 3 factors an attention level of some identified individuals (e.g., members of the example household of FIG. 1) more heavily into a calculation of a collective engagement level for the audience more than others individuals. For example, an adult family member such as a father and/or a mother may be more heavily factored into the engagement level calculation than an underage family member. As described above, the example meter 106 is capable of identifying a person in the audience as, for example, a father of a household. In some examples, an attention level of the father contributes a first percentage to the engagement level calculation and an attention level of the mother contributes a second percentage to the engagement level calculation when both the father and the mother are detected in the audience. For example, the engagement level calculator 300 of FIG. 3 uses a weighted sum to enable the engagement of some audience members to contribute to a “whole-room” engagement score than others. The weighted sum used by the example engagement level calculator 300 can be generated by Equation 1 below.

$$RoomScore = \frac{\begin{matrix}{DadScore}^{*} ( 0.3 ) + {MomScore}^{*} ( 0.3 ) + \\ {TeenagerScore}^{*} ( 0.2 ) + {ChildScore}^{*} ( 0.1 )\end{matrix}}{\begin{matrix}FatherScore + MotherScore + \\ TeenagerScore + ChildScore\end{matrix}} \qquad Equation 1$$

The above equation assumes that all members of a family are detected. When only a subset of the family is detected, different weights may be assigned to the different family members. Further, when an unknown person is detected in the room, the example engagement level calculator 300 of FIG. 3 assigns a default weight to the engagement score calculated for the unknown person. Additional or alternative combinations, equations, and/or calculations are possible.

Engagement levels generated by the example engagement level calculator 300 of FIG. 3 are stored in an engagement level database 310. The example behavior monitor 208 of FIG. 3 also includes a media database 312 from which a media selector 314 is to select pieces of media for presentation to an audience based on, for example, the engagement levels of the engagement level database 310. The example media database 312 of FIG. 3 receives and stores media (e.g., advertisements) for display on the presentation device 102, from any suitable source. For example, the example meter 106 includes a communication interface (e.g., via the multimodal sensor 104) to enable the meter 106 to communicate over a network, such as the Internet. As such, the media database 312 of FIG. 3 receives media from any suitable source (e.g., a television service provider) over the Internet, via a satellite connection, via cable access to a cable service provider, etc. The example media database 312 of FIG. 3 stores the media locally such that the media can be selected for display on, for example, the presentation device 102 and/or on any other media presentation device associated with the environment 100 of FIG. 1.

In the illustrated example of FIG. 3, the media database 312 includes a plurality of media collections 316-322 that are ranked according to, for example, a tier system or structure. The example media collections 316-322 are populated with any suitable type of media, such as advertisements, from any suitable media source, such as advertisers. In some examples, the media collections 316-322 are categorized according to one or more schemes. For example, some of the media collections, such as a Tier One media collection 316 and a Tier Two media collection 318, are referred to as premium media collections, some of the media collections, such as a Tier Three media collection 320, are referred to as preferred media collections, and some of the media collections, such as a Tier Four media collection through a Tier N media collection 322, are referred to as standard media collections. In some examples, the tiers of a single category are ranked among each other. For instance, in the example of FIG. 3, the Tier One media collection 316 and the Tier Two media collection 318 are categorized as premium media collections. The media of the Tier One media collection 316 is ranked higher than the media of the Tier Two media collection 318. Additional or alternative tier(s), categorization(s), and/or scheme(s) are possible.

In the illustrated example of FIG. 3, the media selector 314 selects one of the media collections 316-322 as a source for media to be presented on the presentation device 102 at, for example, a commercial break in a stream of media (e.g., a television program). That is, the example media selector 314 of FIG. 3 is triggered to select one or more pieces of media for presentation and, in response, makes a source selection from the media database 312. In the illustrated example, the media selector 314 is in communication with one or more media presentation devices, such as the presentation device 102, thereby enabling the selected media from the media database 312 to be conveyed to the media presentation device(s) for presentation thereon.

In some instances, the media selector 314 selects a source of media (e.g., one of the media collections 316-322 and/or another media source) according to a schedule and/or agreement for certain media to be presented. However, in some instances, the example media selector 314 selects one of the media collections 316-322 of the media database 312 based on data stored in the example engagement level database 310. As described above, the example engagement level database 310 of FIG. 3 includes information indicative of how attentive one or more audience members are to the presentation device 102 at a particular time (e.g., over the last minute or five minutes). The example media selector 314 of FIG. 3 uses the person specific and/or collective engagement level information of the database 310 to make a selection of one of the media collections 316-322 as the source for one or more pieces of media. In the illustrated example, the media selector 314 determines (e.g., in real time) when an audience (as a whole or individually) is paying attention to the presentation device 102. For example, the media selector 314 of FIG. 3 compares a current engagement level of the audience and/or an audience member to one or more thresholds. The threshold(s) used by the example media selector 314 are, for example, points on the score rankings described above in connection with Tables 1-4. For example, a first one of the thresholds used by the example media selector 314 of FIG. 3 is a value of eight (8) on the scale of one (1) to ten (10) used in Tables 1-4. Thus, the example media selector 314 of FIG. 3 considers an engagement score of eight or greater as meeting the first threshold. A second one of the thresholds used by the example media selector 314 of FIG. 3 is a value of five (5). Thus, the example media selector 314 of FIG. 3 considers an engagement score of five (5), six (6) or seven (7) as meeting the second threshold and not meeting the first threshold. A third one of the thresholds used by the example media selector 314 of FIG. 3 is a value of two (2). Thus, the example media selector 314 of FIG. 3 considers an engagement score of two (2), three (3) or four (4) as meeting the third threshold, not meeting the second threshold, and not meeting the first threshold. Further, the example media selector 314 of FIG. 3 considers an engagement score of one (1) or zero (0) as not meeting any of the thresholds. In the example of FIG. 3, the thresholds are maintained by the media selector 314 according to, for example, rules set by an administrator of the meter 106 and/or a content delivery system provider (e.g., a provider of the STB 110 of FIG. 1).

In the illustrated example of FIG. 3, when audience member(s) are exhibiting behavior indicative of a first level of attentiveness to the presentation device 102 (e.g., the person specific and/or collective engagement level meets the first threshold defined in the media selector 314), the example media selector 314 of FIG. 3 selects a first one of the media collections 316-322 as the source of a media selection. In the illustrated example, the first threshold corresponds to the Tier One media collection 316. Further, when audience member(s) are exhibiting behavior indicative of a second level of attentiveness lesser than the first level of attentiveness (e.g., the person specific and/or collective engagement level does not meet the first threshold and meets the second threshold), the example media selector 314 of FIG. 3 selects a second one of the media collections 316-322 as the source of a media selection. In the illustrated example, the second threshold corresponds to the Tier Two media collection 318. Further, when audience member(s) are exhibiting behavior indicative of a third level of attentiveness lesser than the second level of attentiveness (e.g., the person specific and/or collective engagement level meets the third threshold, does not meet the second threshold, and does not meet the first threshold), the example media selector 314 of FIG. 3 selects a third one of the media collections 316-322 as the source of a media selection. In the illustrated example, the third threshold corresponds to the Tier Three media collection 320. The selection made by the example media selector 314 of FIG. 3 follows such a pattern through the Tier N media collection 322.

Thus, the example media selector 314 of FIG. 3, in conjunction with the example engagement level calculator 300 of FIG. 3, enables selection of a source of media based on a current degree of person specific and/or collective engagement with a media presentation device. Such a selection is desirable to, for example, advertisers that benefit from audience members paying attention to presented advertisements. That is, advertisers desire commercials to be seen at times of increased attentiveness to the presentation device 102 and will desire to have their commercials placed in the higher tiered media collections 316-322 of the media database 312. As media sources benefit from an ability to present media to an attentive audience, the example behavior monitor 208 of FIG. 3 requires one or more conditions or terms (e.g., higher payment) for placement of media into, for example, one of the premium media collections of the example media database 312. For example, to have media placed in the Tier One media collection 316, a media source is required to pay a corresponding first fee (e.g., an additional and/or increased fee relative to the lower collection). The fee required to have media placed in a premium media collection can depend on, for example, a period of time to be stored in the premium media collection, a number of selections to be made from the premium media collection, and/or any suitable metric, measurement, or term. The fee or premium is paid, for example, up front when the media is supplied to the media database 312 and/or retroactively when the media is actually presented (e.g., as detected by the media detector 202 and/or the media selector 314).

In some examples, demographic information of the audience is also factored into the selection of the media. For example, an identity of a father of the household may be tied to demographic information related to the father. Because advertisements can be tailored to specific demographics, the example media database 312 of FIG. 3 can include media that is targeted to one or more specific demographics, such as the demographic categories of the father. If an advertiser is associated with such a piece of media (an advertisement targeted to the demographic of the father), the example behavior monitor 208 of FIG. 3 enables the advertiser to request that the advertisement be presented when persons with the demographics of the father are paying high levels of attention to a television. As described above, such a request may cost the advertiser a premium or fee (e.g., in addition to the premium or fee paid for placement into a certain one of the media collections 316-322). The example media selector 314 of FIG. 3 can recognize whether the person specific engagement level associated with a person of the desired demographics in the environment 100 is high and, in response select the targeted advertisement from the media database 312 for display when that person is paying attention in real time.

Alternatively, the example media selector 314 can select one or more of the tiered media collections 316-322 of FIG. 3 without consideration or regard to the demographic makeup of the audience and/or identifications of people in the current audience.

While an example manner of implementing the behavior monitor 208 of FIG. 2 has been illustrated in FIG. 3, one or more of the elements, processes and/or devices illustrated in FIG. 3 may be combined, divided, re-arranged, omitted, eliminated and/or implemented in any other way. Further, the example engagement level calculator 300, the example eye tracker 302, the example pose identifier 304, the example audio detector 306, the example position detector 308, the media selector 314, and/or, more generally, the example behavior monitor 208 of FIG. 3 may be implemented by hardware, software, firmware and/or any combination of hardware, software and/or firmware. Thus, for example, any of the example engagement level calculator 300, the example eye tracker 302, the example pose identifier 304, the example audio detector 306, the example position detector 308, the media selector 314, and/or, more generally, the example behavior monitor 208 of FIG. 3 could be implemented by one or more circuit(s), programmable processor(s), application specific integrated circuit(s) (ASIC(s)), programmable logic device(s) (PLD(s)) and/or field programmable logic device(s) (FPLD(s)), field programmable gate array (FPGA), etc. When any of the apparatus or system claims of this patent are read to cover a purely software and/or firmware implementation, at least one of the example engagement level calculator 300, the example eye tracker 302, the example pose identifier 304, the example audio detector 306, the example position detector 308, the media selector 314, and/or, more generally, the example behavior monitor 208 of FIG. 3 are hereby expressly defined to include a tangible computer readable storage medium such as a storage device (e.g., memory) or an optical storage disc (e.g., a DVD, a CD, a Bluray disc) storing the software and/or firmware. Further still, the example behavior monitor 208 of FIG. 3 may include one or more elements, processes and/or devices in addition to, or instead of, those illustrated in FIG. 3, and/or may include more than one of any or all of the illustrated elements, processes and devices.

FIG. 4 is a block diagram of an example implementation of the example behavior tracker 218 of FIG. 2. The example behavior tracker 218 of FIG. 4 includes an engagement ratings generator 400 to generate person specific and/or collective engagement ratings for media detected by the example media detector 202 of FIG. 2. As described above, information identifying the media presented in the environment 100 and person specific and/or collective engagement levels detected at the time the identified media was presented are conveyed to the data collection facility 216 of FIG. 2. The example engagement ratings generator 400 of FIG. 4 assigns the person specific and/or collective engagement levels to the corresponding portion(s) of the detected media to formulate person specific and/or collective engagement ratings for the media and/or portion(s) thereof. That is, the example engagement ratings generator 400 of FIG. 4 generates data indicative of how attentive members of the audience (e.g., individually and/or as a group) were with respect to the presentation device 102 when different portions of a piece of media and/or different pieces of media were presented on the presentation device 102. In the illustrated example, the engagement ratings generator 400 generates person specific and/or collective engagement ratings for pieces of media as a whole, such as an entire television show, using an average (person specific and/or collective) engagement level detected in the environment 100 throughout the presentation of the media. In some examples, the engagement ratings are more granular and are assigned to different portions of the same media, thereby allowing determinations about the popularity of persons, actors, scenes, etc.

Additionally or alternatively, the example behavior tracker 218 of FIG. 4 includes an engagement function calculator 402 to calculate an engagement function that varies over a period of time corresponding to a piece of media. That is, the example engagement function calculator 402 of FIG. 4 determines how person specific and/or collective engagement levels provided by the example behavior monitor 208 vary over the course of a presentation of media, such as a television show. For example, the engagement function calculator 402 of FIG. 4 may determine that a first person specific and/or collective engagement level was detected during a first segment (e.g., a portion between commercial breaks) of a television show or a first scene of the television show. The example engagement function calculator 402 of FIG. 4 may also determine that a second person specific and/or collective engagement level of the audience was detected during a second segment or a second scene of the television show. As the detected person specific and/or collective engagement levels vary from segment to segment or scene to scene, the example engagement function calculator 402 of FIG. 4 formulates a function that tracks the changes of the engagement levels. The resulting function can be paired with identifiable objects, events and/or other aspects of the media to determine how attentive the audience (individually or as a whole) was to the presentation device 102 in response to the identifiable aspects (e.g., scenes, actors, products, etc.) of the media being presented.

The example behavior tracker 218 of FIG. 4 also includes a metric aggregator 404. The person specific and/or collective engagement ratings calculated by the example engagement ratings generator 400 and/or the person specific and/or collective engagement functions calculated by the example engagement function generator 402 for the environment 100 are aggregated with similar information collected at different environments (e.g., other living rooms). The audience measurement entity associated with the data collection facility 216 of FIG. 2 has access to statistical information associated with other environments, households, regions, demographics, etc. that the example metric aggregator 404 of FIG. 4 uses to generate cumulative statistics related to the person specific and/or collective engagement levels provided by the example behavior monitor 208 and/or the example behavior tracker 218.

While an example manner of implementing the behavior tracker 218 of FIG. 2 has been illustrated in FIG. 4, one or more of the elements, processes and/or devices illustrated in FIG. 4 may be combined, divided, re-arranged, omitted, eliminated and/or implemented in any other way. Further, the example engagement ratings generator 400, the example engagement function generator 402, the example metric aggregator 404, and/or, more generally, the example behavior tracker 218 of FIG. 4 may be implemented by hardware, software, firmware and/or any combination of hardware, software and/or firmware. Thus, for example, any of the example engagement ratings generator 400, the example engagement function generator 402, the example metric aggregator 404, and/or, more generally, the example behavior tracker 218 of FIG. 4 could be implemented by one or more circuit(s), programmable processor(s), application specific integrated circuit(s) (ASIC(s)), programmable logic device(s) (PLD(s)) and/or field programmable logic device(s) (FPLD(s)), field programmable gate array (FPGA), etc. When any of the apparatus or system claims of this patent are read to cover a purely software and/or firmware implementation, at least one of the example engagement ratings generator 400, the example engagement function generator 402, the example metric aggregator 404, and/or, more generally, the example behavior tracker 218 of FIG. 4 are hereby expressly defined to include a tangible computer readable storage medium such as a storage device (e.g., memory) or an optical storage disc (e.g., a DVD, a CD, a Bluray disc) storing the software and/or firmware. Further still, the example behavior tracker 218 of FIG. 4 may include one or more elements, processes and/or devices in addition to, or instead of, those illustrated in FIG. 4, and/or may include more than one of any or all of the illustrated elements, processes and devices.

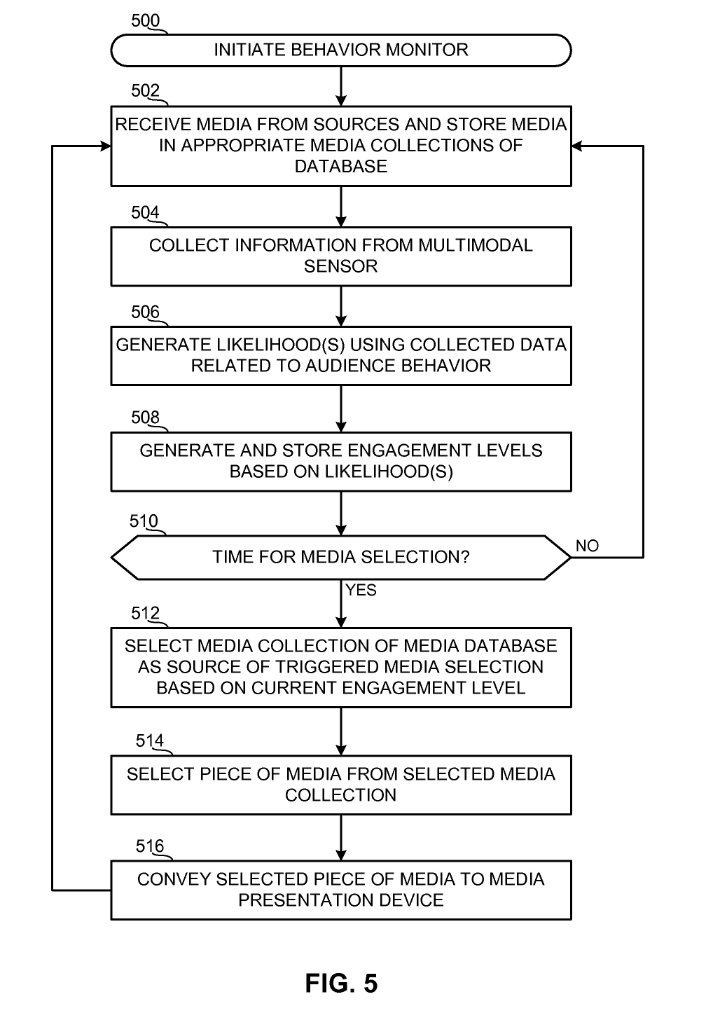

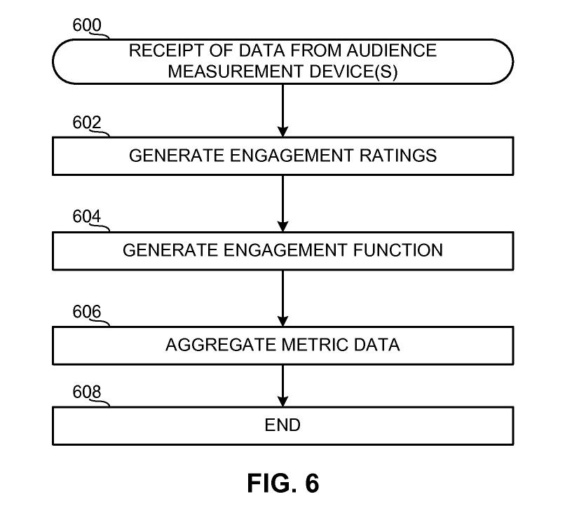

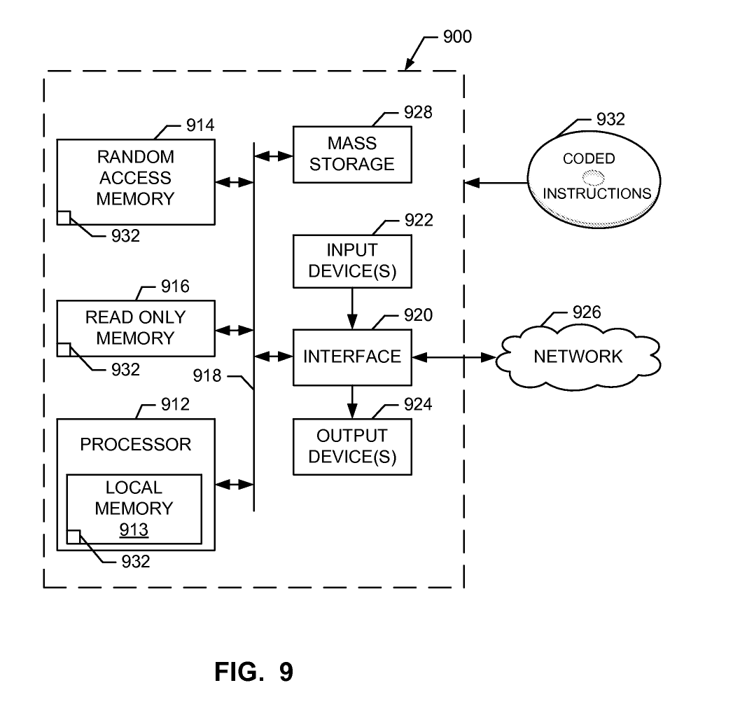

FIG. 5 is a flowchart representative of example machine readable instructions for implementing the example behavior monitor 208 of FIGS. 2 and/or 3. FIG. 6 is a flowchart representative of example machine readable instructions for implementing the behavior tracker 218 of FIGS. 2 and/or 4. In these examples, the machine readable instructions comprise a program for execution by a processor such as the processor 912 shown in the example processing platform 900 discussed below in connection with FIG. 9. The program may be embodied in software stored on a tangible computer readable storage medium such as a CD-ROM, a floppy disk, a hard drive, a digital versatile disk (DVD), a Blu-ray disk, or a memory associated with the processor 912, but the entire program and/or parts thereof could alternatively be executed by a device other than the processor 912 and/or embodied in firmware or dedicated hardware. Further, although the example programs are described with reference to the flowcharts illustrated in FIGS. 5 and 6, many other methods of implementing the example behavior monitor 208 and/or the example behavior tracker 218 may alternatively be used. For example, the order of execution of the blocks may be changed, and/or some of the blocks described may be changed, eliminated, or combined.

As mentioned above, the example processes of FIGS. 5 and/or 6 may be implemented using coded instructions (e.g., computer readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage medium in which information is stored for any duration (e.g., for extended time periods, permanently, brief instances, for temporarily buffering, and/or for caching of the information). As used herein, the term tangible computer readable storage medium is expressly defined to include any type of computer readable storage device and/or storage disc and to exclude propagating signals. Additionally or alternatively, the example processes of FIGS. 5 and/or 6 may be implemented using coded instructions (e.g., computer readable instructions) stored on a non-transitory computer readable storage medium such as a hard disk drive, a flash memory, a read-only memory, a compact disk, a digital versatile disk, a cache, a random-access memory and/or any other storage medium in which information is stored for any duration (e.g., for extended time periods, permanently, brief instances, for temporarily buffering, and/or for caching of the information). As used herein, the term non-transitory computer readable storage medium is expressly defined to include any type of computer readable storage device or storage disc and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

The example flowchart of FIG. 5 begins with an initiation of the example behavior monitor 208 of FIG. 3 (block 500). The example media database 312 receives media from one or more sources (e.g., the STB 110, a web server associated with the multimodal sensor 104 of FIG. 2 over the Internet, a satellite television provider, etc.) and places the received media in the appropriate media collection of the media database 312 (block 502). As described above, placement of the received media is based on, for example, which of a plurality of available fees were paid by respective ones of the media sources of the received media. The example media database 312 receives the media on a periodic or aperidoic basis and/or in response to a request.

The example engagement level calculator 300 collects and/or receives data from the multimodal sensor 104 of FIG. 2 indicative of current conditions of the audience in the environment 100 of FIG. 1 (block 504). One or more of the components of the example engagement level calculator 300, such as the eye tracker 302, the pose identifier 304, the audio detector 306, and/or the position detector 308 generate one or more likelihoods and/or percentages indicative of whether detected audience members are paying attention to, for example, the presentation device 102 (block 506). The example engagement level calculator 300 uses the likelihood(s) and/or percentages calculated by, for example, the eye tracker 302, the pose identifier 304, the audio detector 306, and/or the position detector 308 to generate one or more person specific and/or collective engagement levels for one or more periods of time (block 508). The calculated engagement levels are stored in the example engagement level database 310.

The example media selector 314 determines whether a time and/or segment has arrived (e.g., a commercial break) for selection of a piece of media, such as an advertisement, for presentation to the audience (block 510). If such a time has not arrived, control returns to block 502. If such a time has arrived (block 510), the example media selector 314 is triggered to select at least one piece of media from the media database 312 for presentation on the presentation device 102. To do so, the media selector 314 selects one of the media collections 316-322 based on engagement levels stored of the engagement level database 310 (e.g., a current engagement level corresponding to the previous minute or three minutes (block 512). For example, if the engagement levels corresponding to a recent period of time are greater (e.g., on average) than a first threshold associated with the Tier One media collection 316, the example media selector 314 selects the Tier One media collection 316 (block 512). In such instances, media sources that have entered media into the highest ranked media collection (the Tier One media collection 316) will have their media presented to the audience at a time when the audience is likely paying a first, high degree of attention to the presentation device 102. To continue the above example, if the recent engagement levels are less than the first threshold associated with the Tier One media collection 316 but greater than a second threshold associated with the Tier Two media collection 318, the example media selector 314 selects the Tier Two media collection 316 (block 512). In such instances, media sources that have entered media into the second highest ranked media collection (the Tier Two media collection 318) will have their media presented to the audience at a time when the audience is likely a second degree of attention to the presentation device 102 that is relatively high, but not as high as the first degree of attention associated with the first threshold.

When the media selector 314 of FIG. 3 has selected one of the media collections 316-322 from the media database 312 (bloc 512), the media selector 314 selects one or more pieces of media from the selected one of the media collections 316-322 (block 514). Further, the selected piece(s) of media are conveyed to the presentation device 102 for presentation to the audience. Therefore, the example of FIG. 5 provides real time presentation of media to the audience in accordance with a level of attention currently being paid to the presentation device 102.

FIG. 6 begins with a receipt of data at the example behavior tracker 218 of FIG. 4 from one or more audience measurement devices (e.g., the meter 106 of FIGS. 1 and/or 2) (block 600). In the example of FIG. 6, the engagement ratings generator 400 generates engagement level ratings information for corresponding media received in conjunction with the engagement level information (block 602). Further, the example engagement function calculator 402 generates one or more engagement functions for one or more of the piece(s) of media received at the behavior tracker 218 (block 604). In the illustrated example, the metric aggregator 404 aggregates the calculated information for one media exposure environment, such as a first room of a first house, with calculated information for another media exposure environment, such as a second room of a second house or a second room of the first house (block 606). The example of FIG. 6 then ends (block 608).

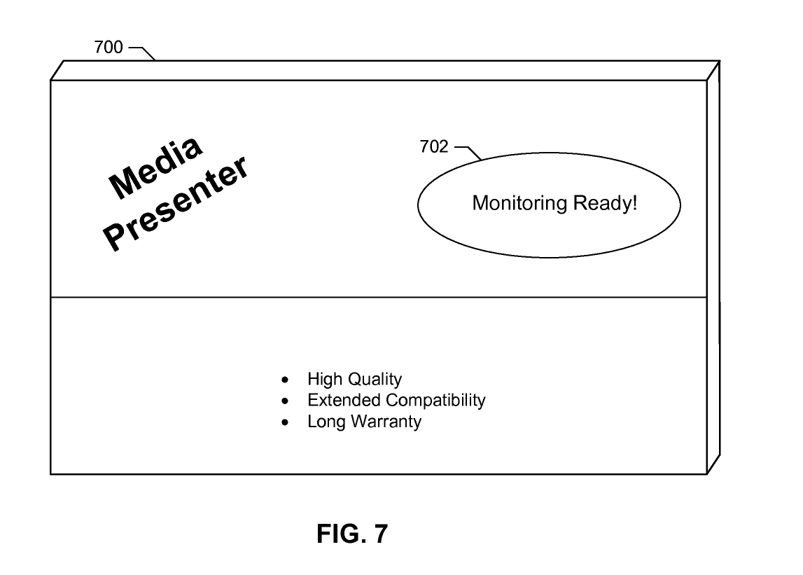

FIG. 7 illustrates example packaging 700 for a media presentation device having the example meter 106 of FIGS. 1-4 installed thereon. The example meter 106 may be installed on, for example, the presentation device 102 of FIG. 1, the video game system 108 of FIG. 1, the STB 110 of FIG. 1, and/or any other suitable media presentation device. Additionally or alternatively, as described above, the example meter 106 may be installed on the multimodal sensor 104 of FIG. 1. The multimodal sensor 104 may be packaged in packaging similar to the packaging 700 of FIG. 7. The example packaging 700 of FIG. 7. includes a label 702 indicating that the media presentation device packaged therein is ‘monitoring ready,’ signifying that the packaged media presentation device includes the example meter 106. For example, the indication of ‘monitoring ready’ indicates to a purchaser that the media presentation device in the packaging 700 has been implemented to, for example, monitor media exposure, detect audience information, and/or transmit monitoring data to a central facility (e.g., the data collection facility 216 of FIG. 2.). For example, a monitoring entity may provide a manufacturer of the media presentation device, which is sold in the packaging 700, with a software development kit (SDK) for integrating the example meter 106 and/or other monitoring functionality in the media presentation device to perform the collection of and/or sending of monitoring information to the monitoring entity. In other examples, the meter 106 is implemented by a hardware circuit such as an ASIC dedicated to the monitoring installed in the media presentation device during manufacturing. In some examples, the metering circuit is deactivated unless and until permission from the purchaser is received as explained below. The meter of the media presentation device of the example packaging 700 of FIG. 7 may be configured to perform monitoring when the media presentation device is powered on. Alternatively, the meter of the media presentation device of the example packaging 700 of FIG. 7 may request user input (e.g., accepting an agreement, enabling a setting, installing functionality (e.g., downloading monitoring functionality from the internet and installing the functionality, etc.) before enabling monitoring. Alternatively, a manufacturer of the media presentation device may not include monitoring functionality in the media presentation device at the time of purchase and the monitoring functionality may be made available by the manufacturer, by a monitoring entity, by a third party, etc. for retrieval/download and installation on the media presentation device.

In the illustrated example of FIG. 7, the meter 106 is installed in the media presentation device prior to the retail point of sale (e.g., at the site of manufacturing of the media presentation device). In some examples, the meter 106 is not initially installed, but software requesting authorization to install the meter 106 is installed prior to the point of sale. The software of some such examples is initiated at the startup of the media presentation device to request the purchaser to authorize downloading and/or activation of the meter 106.

In some examples, consumers are offered an incentive (e.g., a rebate, a discount, a service, a subscription to a service, a warranty, an extended warranty, etc.) to download and/or activate the meter 106. The ‘monitoring enabled’ label 702 of the packaging 700 may be a part of an advertisement alerting a potential purchaser to the incentive. Providing such an incentive may promote sales of the media presentation device (e.g., by lowering the purchase price) and enable the monitoring entity to expand the size of its panel(s). Purchasers accepting the incentive may be required to provide demographic information and/or to register as a panelist with the monitoring entity to receive the incentive.

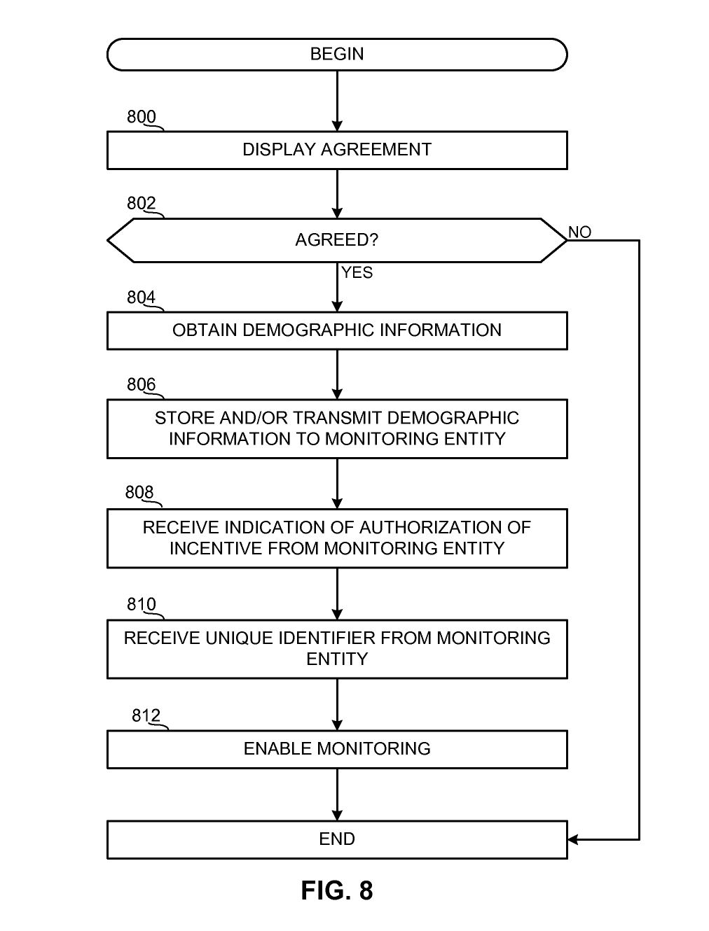

FIG. 8 is a flowchart representative of example machine readable instructions for enabling monitoring functionality on the media presentation device of FIG. 7 (e.g., to authorize functionality of the example meter 106). The instructions of FIG. 8 may be utilized when the media presentation device of FIG. 7 is not enabled for monitoring by default (e.g., is not enabled upon purchase of the media presentation device without authorization of the purchaser). The example instructions of FIG. 8 begin when the media presentation device of FIG. 7 is powered on. Additionally or alternatively, the example instructions of FIG. 8 may begin when a user of the media presentation device accesses a menu to enable monitoring.

The media presentation device of FIG. 7 displays an agreement that explains the monitoring process, requests consent for monitoring usage of the media presentation device, provides options for agreeing (e.g., an ‘I Agree’ button) or disagreeing (‘I Disagree’) (block 800). The media presentation device then waits for a user to indicate a selection (block 802). When the user indicates that the user disagrees (e.g., does not want to enable monitoring), the instructions of FIG. 8 terminate. When the user indicates that the user agrees (e.g., that the user wants to be monitored), the media presentation device obtains demographic information from the user and/or sends a message to the monitoring entity to telephone the purchaser to obtain such information (block 804). For example, the media presentation device may display a form requesting demographic information (e.g., number of people in the household, ages, occupations, an address, phone numbers, etc.). The media presentation device stores the demographic information and/or transmits the demographic information to, for example, a monitoring entity associated with the data collection facility 216 of FIG. 2 (block 806). Transmitting the demographic information may indicate to the monitoring entity that monitoring via the media presentation device of FIG. 7 is authorized. In some examples, the monitoring entity stores the demographic information in association with a panelist and/or device identifier (e.g., a serial number of the media presentation device) to facilitate development of exposure metrics, such as ratings. In response, the monitoring entity authorizes an incentive (e.g., a rebate for the consumer transmitting the demographic information and/or for registering for monitoring). In the example of FIG. 8, the media presentation device receives an indication of the incentive authorization from the monitoring entity (block 808). The monitoring entity of the illustrated example transmits an identifier (e.g., a panelist identifier) to the media presentation device for uniquely identifying future monitoring information sent from the media presentation device to the monitoring entity (block 810). The media presentation device of FIG. 7 then enables monitoring (e.g., by activating the meter 106) (block 812). The instructions of FIG. 8 are then terminated.

FIG. 9 is a block diagram of an example processor platform 900 capable of executing the instructions of FIG. 5 to implement the example behavior monitor 208 of FIGS. 2 and/or 3, executing the instructions of FIG. 6 to implement the example behavior tracker 218 of FIGS. 2 and/or 4, and/or executing the instructions of FIG. 8 to implement the example meter 106 of FIGS. 1-4. The processor platform 900 can be, for example, a server, a personal computer, a mobile phone, a personal digital assistant (PDA), an Internet appliance, a DVD player, a CD player, a digital video recorder, a BluRay player, a gaming console, a personal video recorder, a set-top box, an audience measurement device, or any other type of computing device.

The processor platform 900 of the instant example includes a processor 912. For example, the processor 912 can be implemented by one or more hardware processors, logic circuitry, cores, microprocessors or controllers from any desired family or manufacturer.

The processor 912 includes a local memory 913 (e.g., a cache) and is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), and/or a PCI express interface.

One or more input devices 922 are connected to the interface circuit 920. The input device(s) 922 permit a user to enter data and commands into the processor 912. The input device(s) can be implemented by, for example, a keyboard, a mouse, a touchscreen, a track-pad, a trackball, isopoint and/or a voice recognition system.

One or more output devices 924 are also connected to the interface circuit 920. The output devices 924 can be implemented, for example, by display devices (e.g., a liquid crystal display, a cathode ray tube display (CRT), a printer and/or speakers). The interface circuit 920, thus, typically includes a graphics driver card.

The interface circuit 920 also includes a communication device such as a modem or network interface card to facilitate exchange of data with external computers via a network 926 (e.g., an Ethernet connection, a digital subscriber line (DSL), a telephone line, coaxial cable, a cellular telephone system, etc.).

The processor platform 900 of the illustrated example also includes one or more mass storage devices 928 for storing software and data. Examples of such mass storage devices 928 include floppy disk drives, hard drive disks, compact disk drives and digital versatile disk (DVD) drives.

Coded instructions 932 (e.g., the machine readable instructions of FIGS. 5, 6 and/or 8) may be stored in the mass storage device 928, in the volatile memory 914, in the non-volatile memory 916, and/or on a removable storage medium such as a CD or DVD.

Although certain example apparatus, methods, and articles of manufacture have been disclosed herein, the scope of coverage of this patent is not limited thereto. On the contrary, this patent covers all apparatus, methods, and articles of manufacture fairly falling within the scope of the claims of this patent.

What is claimed is:

1. A method, comprising:
generating, using a logic circuit, an engagement level based on information related to an audience member in a media exposure environment; and
selecting, based on the engagement level, one of a plurality of media collections from which a piece of media is to be select for presentation in the media exposure environment.

2. A method as defined in claim 1, wherein the media collections are ranked according to a tier structure.

3. A method as defined in claim 2, further comprising, when the engagement level is above a threshold, selecting a first one of the ranked media collections having a higher ranking than a second one of the ranked media collections.

4. A method as defined in claim 1, wherein pieces of media associated with a first one of the media collections is media for which a premium has been paid by a corresponding entity.

5. A method as defined in claim 1, wherein a value of the engagement level is representative of a likelihood that a person in the media exposure environment is paying attention to a media presentation device.

6. A method as defined in claim 1, further comprising detecting a portion of a media stream in which an advertisement is to be inserted, and inserting the piece of media from the selected media collection into the detected portion of the media stream.

7. A method as defined in claim 1, wherein generating the engagement level comprises aggregating a plurality of likelihoods of engagement associated with a plurality of audience members.

8. A method as defined in claim 1, wherein generating the level of engagement comprises analyzing an eye position by comparing a gaze direction of an audience member to a direct line of sight for the audience member.

9. A method as defined in claim 1, wherein generating the level of engagement comprises determining whether an audience member is performing a gesture known to be associated with a video game system implemented in the environment.

10. A method as defined in claim 1, wherein generating the level of engagement comprises determining a directional aspect of an audio signal detected in the environment in comparison to a position of a presentation device.

11. A tangible machine readable storage medium comprising instructions that, when executed, cause a machine to at least:
generate an engagement level based on information related to an audience member in a media exposure environment; and
select, based on the engagement level, one of a plurality of media collections from which a piece of media is to be selected for presentation in the media exposure environment.

12. A storage medium as defined in claim 11, wherein the media collections are ranked according to a tier structure.

13. A storage medium as defined in claim 13, wherein the instructions cause the machine to, when the engagement level is above a threshold, select a first one of the ranked media collections having a higher ranking than a second one of the ranked media collections.

14. A storage medium as defined in claim 11, wherein pieces of media associated with a first one of the media collections is media for which a premium has been paid by a corresponding entity.

15. A storage medium as defined in claim 11, wherein a value of the engagement level is representative of a likelihood that a person in the media exposure environment is paying attention to a media presentation device.

16. A storage medium as defined in claim 11, wherein the instructions cause the machine to detect a portion of a media stream in which an advertisement is to be inserted, and insert the piece of media from the selected ranked media collection into the detected portion of the media stream.

17. A storage medium as defined in claim 11, wherein the instructions cause the machine to generate the engagement level by analyzing at least one of an eye position of an audience member, an eye movement of the audience member, a pose of the audience member, a gesture of the audience member, a posture of the audience member, a position of the audience member relative to a media presentation device, or audio information.

18. An apparatus, comprising:
a calculator to determine an engagement level associated with an audience in a media exposure environment; and
a selector to:
compare the engagement level to a first threshold associated with a first media collection at a first tier of a media database;
when the engagement level is greater than the first threshold, select the first media collection as a source for a piece of media to be inserted into a media stream;
when the engagement level is lower than the first threshold, compare the engagement level to a second threshold associated with a second media collection at a second tier of a media database having a lower rank than the first media collection; and
when the engagement level is less than the first threshold and greater than the second threshold, select the second media collection as the source for the piece of media to be inserted into the media stream.

19. An apparatus as defined in claim 18, wherein fees required to have media placed in the first collection are higher than fees to have the media placed in the second media collection.

20. An apparatus as defined in claim 18, wherein the selector is to select the piece of media from the selected media collection based on a demographic associated with the audience.

21. An apparatus as defined in claim 18, wherein the calculator is to generate the level of engagement by analyzing at least one of a pose of the audience member, a gesture of the audience member, a posture of the audience member, or a position of the audience member relative to a media presentation device.

22. An apparatus as defined in claim 18, wherein the calculator is to generate the level of engagement by analyzing at least one of an eye position of an audience member or an eye movement of the audience member.

23. An apparatus as defined in claim 18, wherein the calculator is to generate the level of engagement by analyzing audio information.

24. An apparatus as defined in claim 18, wherein the first media collection is classified differently from the second media collection.

25. An apparatus as defined in claim 18, wherein the engagement level is representative of a likelihood that a corresponding member of the audience is paying attention to a media presentation device.
